(19) United States
(12) Patent Application Publication
(10) Pub. No.: US 2026/0222565 A1
(43) Pub. Date: Jul. 30, 2026

(54) CODING METHOD, DECODING METHOD, CODER, DECODER, AND STORAGE MEDIUM

(71) Applicant: GUANGDONG OPPO MOBILE TELECOMMUNICATIONS CORP., LTD., Dongguan (CN)

(72) Inventor: Zhihuang XIE, Dongguan (CN)

(73) Assignee: GUANGDONG OPPO MOBILE TELECOMMUNICATIONS CORP., LTD., Dongguan (CN)

(21) Appl. No.: 19/629,048

(22) Filed: Mar. 26, 2026

Related U.S. Application Data
(63) Continuation of application No. PCT/CN2023/122307, filed on Sep. 27, 2023.

(51) Int. Cl. H04N 19/117; H04N 19/14; H04N 19/176; H04N 19/82

(52) U.S. Cl. CPC H04N 19/117; H04N 19/14; H04N 19/176; H04N 19/82

(57) ABSTRACT

An encoding method, a decoding method, and a storage medium are provided. The encoding method includes: determining that a current block is allowed for applying a neural network-based in-loop filtering technique; acquiring a first reconstructed image of the current block; acquiring a first edge image of the current block; inputting the first reconstructed image and the first edge image into a neural network-based in-loop filtering model to obtain a filtered image of the current block; performing cost calculation based on an original image and the filtered image of the current block to determine a first cost value; determining whether the neural network-based in-loop filtering technique is applied to the current block based on the first cost value, and setting first indication information of the current block; and encoding the first indication information, and writing obtained encoded bits into a bitstream.

### CROSS-REFERENCE TO RELATED APPLICATION

This application is a continuation of International Application No. PCT/CN2023/122307 filed on Sep. 27, 2023, the disclosure of which is hereby incorporated by reference in its entirety.

### BACKGROUND

With the increasing demands for video display quality, new video application forms such as high-definition and ultra-high-definition video have emerged as the times require. The Joint Video Exploration Team (JVET) of the International Organization for Standardization (ISO)/International Electrotechnical Commission (IEC) and the International Telecommunication Union Telecommunication Standardization Sector (ITU-T) has developed the next-generation video coding standard H.266/Versatile Video Coding (VVC).

At present, neural networks have been introduced in the field of video codec. With the powerful learning ability of neural networks, codec tools based on neural networks typically deliver highly efficient codec performance. For instance, there are neural network-based intra prediction methods, neural network-based inter-prediction methods and neural network-based in-loop filtering methods, among which the neural network-based in-loop filtering methods boast the most outstanding coding performance. However, the current neural network-based in-loop filtering methods have not fully exploited the advantages of neural network model. In certain codec scenarios, the neural network-based in-loop filtering method yield only a marginal improvement in filtering effects, and may even degrade filtering efficiency. Therefore, neural network-based in-loop filtering methods stand in need of further optimization.

### SUMMARY

Embodiments of the present disclosure relate to the technical field of video encoding and decoding, and particularly relate to a decoding method, an encoding method, and a non-transitory storage medium.

The technical solution of the embodiment of the present disclosure is realized as follows.

According to a first aspect, an embodiment of the present disclosure provides a decoding method applied to a decoder, the method includes the following operations.

A bitstream is decoded and first indication information is determined.

It is determined, based on the first indication information, that a neural network-based in-loop filtering technique is applied to a current block.

A first reconstructed image of the current block is acquired. The first reconstructed image includes a reconstructed sample of the current block.

A first edge image of the current block is acquired. The first edge image includes edge information of the reconstructed sample.

The first reconstructed image and the first edge image are input into a neural network-based in-loop filtering model to obtain a filtered image of the current block.

In a second aspect, an embodiment of the present disclosure provides an encoding method, which is applied to an encoder, and the method includes the following operations.

It is determined that a neural network-based in-loop filtering technique is allowed to be applied to a current block.

A first reconstructed image of the current block is acquired. The first reconstructed image includes a reconstructed sample of the current block.

A first edge image of the current block is acquired. The first edge image includes edge information of the reconstructed sample.

The first reconstructed image and the first edge image are input into a neural network-based in-loop filtering model to obtain a filtered image of the current block.

Cost calculation is performed based on an original image and the filtered image of the current block to determine a first cost value.

It is determined whether the neural network-based in-loop filtering technique is applied to the current block based on the first cost value, and first indication information of the current block is set.

The first indication information is encoded, and obtained encoded bits are written into a bitstream.

In a third aspect, an embodiment of the present disclosure provides a non-transitory computer-readable storage medium storing a bitstream generated by the encoding method of the second aspect.

### BRIEF DESCRIPTION OF THE DRAWINGS

The accompanying drawings described herein are intended to provide a further understanding of the present disclosure and constitute a part of the present disclosure. The schematic embodiments of the present disclosure and the description thereof are intended to explain the present disclosure, and do not constitute an undue limitation of the present disclosure.

FIG. 1 is a schematic block diagram of a composition of an encoder according to an embodiment of the present disclosure.

FIG. 2 is a schematic block diagram of a composition of a decoder according to an embodiment of the present disclosure.

FIG. 3 is a schematic diagram of network architecture of a codec system according to an embodiment of the present disclosure.

FIG. 4 is a schematic flow diagram of an encoding method according to an embodiment of the present disclosure.

FIG. 5 is a schematic diagram of a reconstructed image according to an embodiment of the present disclosure.

FIG. 6 is a schematic diagram of an edge image according to an embodiment of the present disclosure.

FIG. 7 is a schematic diagram of a composition structure of an in-loop filtering model according to an embodiment of the present disclosure.

FIG. 8 is a schematic diagram of a composition structure of another in-loop filtering model according to an embodiment of the present disclosure.

FIG. 9 is a schematic flow diagram of a decoding method according to an embodiment of the present disclosure.

FIG. 10 is a schematic diagram of the composition structure of an encoder according to an embodiment of the present disclosure.

FIG. 11 is a schematic diagram of a specific hardware structure of an encoder according to an embodiment of the present disclosure.

FIG. 12 is a schematic diagram of a composition structure of a decoder according to an embodiment of the present disclosure.

FIG. 13 is a schematic diagram of a specific hardware structure of a decoder according to an embodiment of the present disclosure.

FIG. 14 is a schematic diagram of a composition structure of a codec system according to an embodiment of the present disclosure.

### DETAILED DESCRIPTION

Hereinafter, the technical solutions in the embodiments of the present disclosure will be described with reference to the accompanying drawings in the embodiments of the present disclosure, and it is apparent that the described embodiments are part of the embodiments of the present disclosure, but not all the embodiments. Based on the embodiments in the present disclosure, all other embodiments obtained by those skilled in the art without creative work fall within the scope of protection of the present disclosure.

Unless otherwise defined, all technical and scientific terms used herein have the same meaning as commonly understood by those skilled in the art of the present disclosure. The terminology used herein is for the purpose of describing embodiments of the present disclosure only and is not intended to limit the present disclosure.

In the following description, reference is made to “some embodiments”, which describes a subset of all possible embodiments, but it is understood that “some embodiments” may be the same subset or different subsets of all possible embodiments, and may be combined with each other without conflict.

It should also be note that the terms “first”, “second” and “third” referred to in the embodiments of the present disclosure are only used to distinguish similar objects, and do not denote a specific ordering for the objects, and it is understood that “first”, “second” and “third” may be interchanged with a specific order or sequence where permitted, so that the embodiments of the present disclosure described herein may be implemented in an order other than that illustrated or described herein.

In video images, a first image component, a second image component, and a third image component are generally used to characterize a coding block (CB). The three image components are one luma component, one blue chroma component, and one red chroma component, respectively. Specifically, the luma component is usually represented by the symbol Y, the blue chroma component is usually represented by the symbol Cb or U, and the red chroma component is usually represented by the symbol Cr or V. In this way, the video image may be represented in the YCbCr format or in the YUV format.

Before further describing the embodiments of the present disclosure in detail, the phrases and terms related to the embodiments of the present disclosure will be described first, and the phrases and terms related to the embodiments of the present disclosure are applicable to the following explanations:
Moving Image Experts Group, MPEG
International Standardization Organization, ISO
International Electrotechnical Commission, IEC
Joint Video Experts Team, JVET
Alliance for Open Media, AOM
Next generation video coding standard H.266/Versatile Video Coding, VVC
VVC's reference software test platform, VVC Test Model, VTM
Audio and video coding standard Audio Video Standard, AVS
High-Performance Test Model of AVS, HPM
Transform coefficients
Quantization Parameter, QP
Neural-network based video coding, NNVC
Sample Adaptive Offset, SAO
Deblocking filter, DBF

It is understood that digital video compression technology mainly compresses huge digital video data to facilitate transmission and storage. With the proliferation of Internet video and increasing demands for video clarity, although the existing digital video compression standards can save a lot of video data, it is still necessary to pursue better digital video compression technology to reduce the bandwidth and traffic pressure of digital video transmission.

Current universal video coding and decoding standards (such as H.266/VVC) all adopt a block-based hybrid coding framework. Each frame in the video is partitioned into a square largest coding unit (LCU) of the same size (e.g., 128× 128, 64× 64, etc.). Each LCU may further be partitioned into rectangular coding units (CUs) according to a rule. A coding unit may further be partitioned into a prediction unit (PU prediction unit), a transform unit (TU transform unit), and the like. The hybrid coding framework includes modules such as prediction, transform, quantization, entropy coding, in-loop filter, and the like. The prediction module includes intra prediction module and inter prediction module. Inter prediction includes motion estimation and motion compensation. Given the strong correlation between adjacent pixels within a single video frame, intra prediction is employed in video codec technology to eliminate spatial redundancy between adjacent pixels. Owing to the high similarity between adjacent frames in a video, the inter prediction is applied in video coding and decoding technology to eliminate the temporal redundancy between adjacent frames, thereby improving the coding efficiency.

The basic process of a video codec is as follows. On the encoding side, a frame of an image is partitioned into blocks, and intra prediction or inter prediction is performed on a current block to generate a prediction block for the current block. A residual block is obtained by subtracting the prediction block from the original image block of the current block, and the residual block is transformed and quantized to obtain a quantized coefficient matrix, which is then entropy encoded and output to the bitstream. On the decoding side, intra prediction or inter prediction is applied to the current block to generate a prediction block of the current block, on the other hand, the bitstream is parsed to obtain a quantized coefficient matrix, which undergoes inverse quantization and inverse transformation to obtain a residual block. The prediction block and the residual block are added to obtain a reconstructed block, the reconstructed blocks are combined to form a reconstructed image, and in-loop filtering is then performed on the reconstructed image based on the image or the blocks to obtain a decoded image. The encoding side also needs to perform operations similar to those on the decoding side to obtain the decoded image. The decoded image may be used as a reference frame for inter prediction of subsequent frames. If necessary, the block partitioning information, and the mode or parameter information related to prediction, transformation, quantization, entropy coding, in-loop filtering, etc. determined by the encoding side need to be output to the bitstream again. The decoding side parses the bitstream and analyzes the existing information to determine the identical block partitioning information, the mode or parameter information related to prediction, transformation, quantization, entropy coding, in-loop filtering and other processes as those used by the encoding side, thereby ensuring that the decoded image obtained by the encoding side is consistent with that obtained by the decoding side. The decoded image obtained by the encoding side is also commonly referred to as a reconstructed image. During prediction, the current block may be partitioned into prediction units, and during transformation, the current block may be partitioned into transform units. The partitioning of the prediction units and the transform units may be different. The above describes the basic process of a video codec based on the block-based hybrid coding framework, and with the advancement of technology, some modules or operations of the framework or process may be optimized. The current block may refer to a current coding unit (CU), a current prediction unit (PU), or the like.

JVET, an international organization for formulating video coding standards, has set up a research group dedicated to develop coding models that go beyond H.266/VVC, and named the model (i.e., the platform testing software) ECM. ECM has begun to incorporate updated and more efficient compression algorithms based on VTM10.0, and currently surpasses VVC's encoding performance by about 13%. ECM not only expands the coding unit size of specific resolution, but also integrates many intra and inter prediction technologies.

At present, neural networks have been introduced in the field of video codec. With the powerful learning ability of neural networks, neural networks-based codec tools often have very efficient codec efficiency. For example, among the neural networks-based intra prediction method, the neural networks-based inter prediction method and the neural networks-based in-loop filtering method, the coding performance of the neural networks-based in-loop filtering method is the most prominent.

Hereinafter, embodiments of the present disclosure will be described in detail with reference to the accompanying drawings.

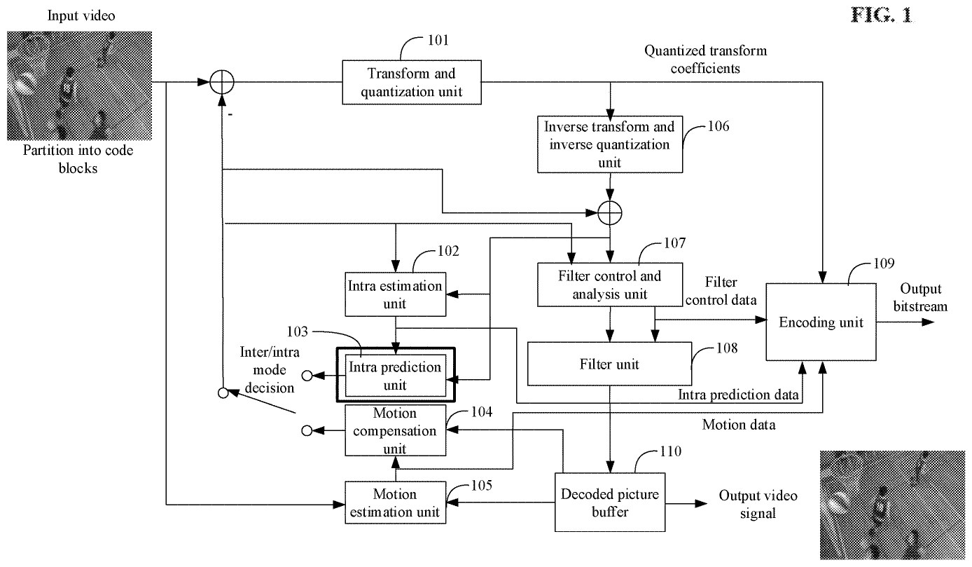

With reference to FIG. 1, a schematic block diagram of a composition of an encoder according to an embodiment of the present disclosure is illustrated. As illustrated in FIG. 1, an encoder (specifically, a “video encoder”) 100 may include a transform and quantization unit 101, an intra estimation unit 102, an intra prediction unit 103, a motion compensation unit 104, a motion estimation unit 105, an inverse transform and inverse quantization unit 106, a filter control and analysis unit 107, a filter unit 108, an encoding unit 109, a decoded image buffer 110, and the like, where the filter unit 108 may implement de-block filtering and sample adaptive indentation (SAO) filtering, and the encoding unit 109 may implement header information encoding and Context-based Adaptive Binary Arithmetic Coding. For an input original video signal, a video coding block may be obtained by partitioning the Coding Tree Unit (CTU), and then, for the residual pixel information obtained from intra or inter prediction, the video coding block is transformed by the transform and quantization unit 101, this process includes transforming the residual information from the pixel domain to the transform domain, and quantizing the obtained transform coefficients to further reduce the bit rate. The intra estimation unit 102 and the intra prediction unit 103 are configured to perform intra prediction on the video coded block. Specifically, the intra estimation unit 102 and the intra prediction unit 103 are configured to determine an intra prediction mode to be used to encode the video coding block. The motion compensation unit 104 and the motion estimation unit 105 are configured to perform inter prediction coding on the received video coded block with respect to one or more blocks in the one or more reference frames to provide temporal prediction information. The motion estimation performed by the motion estimation unit 105 is a process of generating a motion vector that can estimate the motion of the video coded block, and then the motion compensation unit 104 performs motion compensation based on the motion vector determined by the motion estimation unit 105. After determining the intra prediction mode, the intra prediction unit 103 is further configured to supply the selected intra prediction data to the encoding unit 109, and the motion estimation unit 105 also transmits the motion vector data determined by calculation to the encoding unit 109. Further, the inverse transform and inverse quantization unit 106 is used for reconstruction of the video coding block, and reconstruction of a residual block in the pixel domain. The reconstruction of the residual block implements the neural network-based in-loop filtering, de-blocking filtering, SAO filtering, etc., through the filter control and analysis unit 107 and the filter unit 108. The reconstructed residual block is then added to a predictive block in a frame of the decoded image buffer 110 to generate the reconstructed video coding block. The encoding unit 109 is configured to encode various coding parameters and quantized transform coefficients. In the CABAC-based encoding algorithm, the context may be based on adjacent coding blocks, and may be used to encode information indicating the determined intra prediction mode, and output the bitstream of the video signal. The decoded image buffer 110 is used to store the reconstructed video coding block for prediction reference. As the video image encoding progresses, new reconstructed video encoding blocks are continuously generated, and these reconstructed video encoding blocks are stored in the decoded image buffer 110.

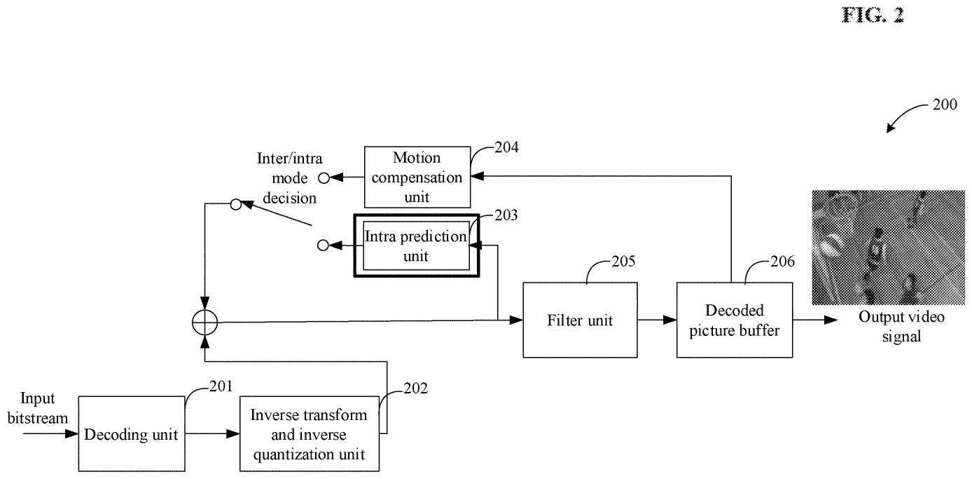

With reference to FIG. 2, a schematic block diagram of a composition of a decoder according to an embodiment of the present disclosure is illustrated. As illustrated in FIG. 2, a decoder (specifically, a “video decoder”) 200 includes a decoding unit 201, an inverse transform and inverse quantization unit 202, an intra prediction unit 203, a motion compensation unit 204, a filter unit 205, a decoded image buffer 206, and the like. The decoding unit 201 may implement header information decoding and CABAC decoding. The filter unit 205 may implement neural network-based in-loop filtering, de-block filtering, SAO filtering, and the like. After the input video signal is encoded as illustrated in FIG. 1, the bitstream of the video signal is outputted. The bitstream is input into the decoder 200 and first processed by the decoding unit 201 to obtain decoded transform coefficients. The transform coefficients are then processed by the inverse transform and inverse quantization unit 202 to generate a residual block in the pixel domain. The intra prediction unit 203 may be configured to generate prediction data for the current video decoded block based on the determined intra prediction mode and data from previously decoded blocks of the current frame or image. The motion compensation unit 204 determines prediction information for the video decoded block by parsing the motion vector and other associated syntax elements, and uses the prediction information to generate a predictive block for the video decoded block being decoded. A decoded video block is formed by summing the residual block from the inverse transform and inverse quantization unit 202 with the corresponding predictive block generated by the intra prediction unit 203 or the motion compensation unit 204. The decoded video signal is processed by the filter unit 205 to remove block artifacts, thereby improving the video quality. The decoded video block is then stored in the decoded image buffer 206, which stores the reference images for subsequent intra prediction or motion compensation, and is also used for the output of the video signal, thus recovering the original video signal.

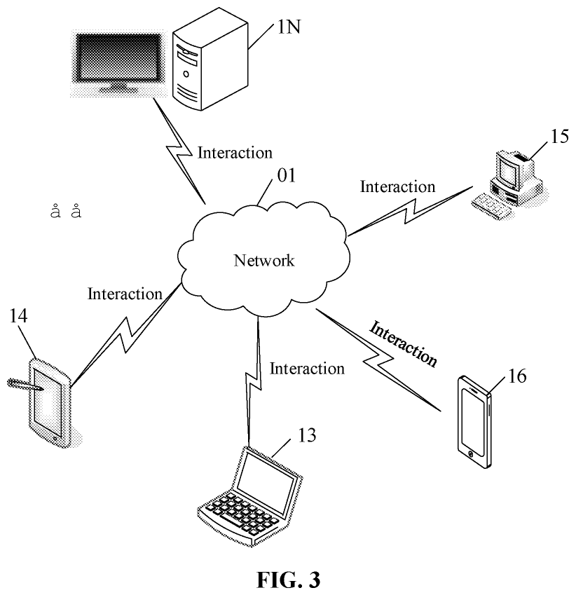

Further, an embodiment of the present disclosure further provides a network architecture of a codec system including an encoder and a decoder. FIG. 3 illustrates a schematic diagram of network architecture of a codec system according to an embodiment of the present disclosure. As illustrated in FIG. 3, the network architecture includes one or more electronic devices 13-IN and a communication network 01. The electronic devices 13-1N may conduct video interaction through the communication network 01. In the course of implementation, the electronic device may be various types of devices having video codec functions, for example, the electronic device may include a smartphone, a tablet computer, a personal computer, a personal digital assistant, a navigator, a digital phone, a video phone, a television, a sensing device, a server, and the like, and it is not specifically limited herein. Further, the decoder or encoder described in the embodiment of the present disclosure may be the above-described electronic device.

It should be noted that the method of the embodiment of the present disclosure is mainly applied to the filter unit 108 as illustrated in FIG. 1 and the filter unit 205 as illustrated in FIG. 2. That is, the embodiments of the present disclosure may be applied to both an encoder and a decoder, or may be applied to both the encoder and the decoder, which is not specifically limited by the embodiments of the present disclosure.

It should also be noted that, when applied to the filter unit 108, the “current block” specifically refers to a coded block to be currently subjected to intra prediction; and when applied to the filter unit 205, the “current block” specifically refers to a decoded block currently to be intra predicted.

In order to facilitate understanding of the technical solutions of the embodiments of the present disclosure, the technical solutions of the present disclosure will be described in detail below with reference to specific examples. As an optional solution, the above related technologies may be arbitrarily combined with the technical solutions of the embodiments of the present disclosure, and all of them belong to the scope of protection of the embodiments of the present disclosure. Embodiments of the present disclosure include at least some of the following.

The embodiment of the present disclosure provides encoding and decoding methods, specifically a neural network-based in-loop filtering method. By inputting the edge image as additional side information into an in-loop filtering model, sample-level edge information may be provided for the network, the learning of filtering strength is adjusted at the sample level, and the filtering effect is improved, thereby enhancing the quality of the reconstructed image and the performance of encoding and decoding.

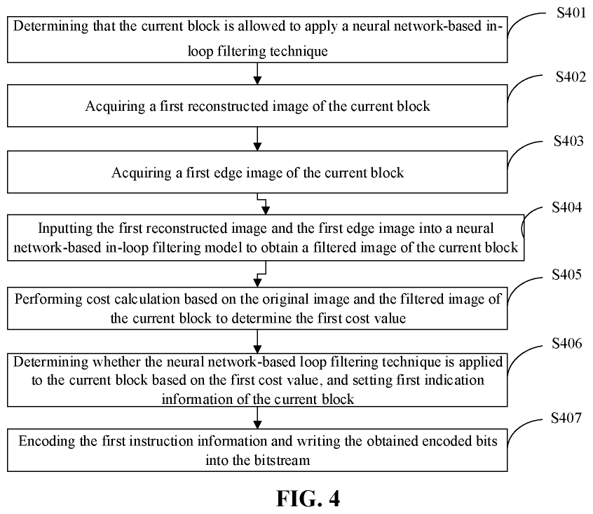

In an embodiment of the present disclosure, FIG. 4 illustrates a schematic flow diagram of an encoding method according to the embodiment of the present disclosure. As illustrated in FIG. 4, the method may include the operations S401, S402 and S403.

At block S401: determining that a neural network-based in-loop filtering technique is allowed to be applied to a current block.

It should be noted that the current block may be any kind of neural network-based in-loop filtering processing unit. In some embodiments, the current block may be a current coding tree unit. In other embodiments, the current block may be a current image block obtained by other partitioning method. In still other embodiments, the current block may also be a current frame.

It should also be noted that the current block includes at least a first color component and a second color component. For the first color component of the current block, the block may be referred to as a first color component block for short. Moreover, when the first color component is a luma component, the first color component block may also be referred to as a luma block. Similarly, for the second color component of the current block, the block may be referred to as the second color component block for short. Moreover, when the second color component is a chroma component, the second color component block may also be referred to as a chroma block.

In some embodiments, the method includes: determining whether the neural network-based in-loop filtering technique is allowed to be applied to the current block based on a flag of a high-layer syntax element of the current block.

At block S402: acquiring a first reconstructed image of the current block. The first reconstructed image includes a reconstructed sample of the current block.

It should be noted that the reconstructed sample may be a reconstructed sample of the luma component, and the first reconstructed image is a reconstructed image of the luma component. The reconstructed sample may also be a reconstructed sample of chroma component, and the first reconstructed image is a reconstructed image of the chroma component.

In some embodiments, the operation of acquiring the first reconstructed image of the current block includes: acquiring an initial reconstructed image of a frame in which the current image is located, and acquiring a first reconstructed image of the current block from the initial reconstructed image. That is, the encoding side performs in-loop filtering on the reconstructed image based on the image or block, and inputs the initial reconstructed image into the in-loop filtering model.

In other embodiments, deblocking filtering is performed on the initial reconstructed image, and a first reconstructed image of the current block is obtained from the filtered image. Alternatively, sample adaptive offset is performed on the initial reconstructed image, and a first reconstructed image of the current block is obtained from the compensated image. Alternatively, deblocking filtering and sample adaptive offset are performed on the initial reconstructed image, and the first reconstructed image of the current block is obtained from the compensated image. That is, the encoding side performs in-loop filtering on the reconstructed image based on the image or the block, and the reconstructed image input into the in-loop filtering model may be other images such as deblocking filtered images or images subjected to sample adaptive offset.

At block S403: acquiring a first edge image of the current block. The first edge image includes edge information of the reconstructed sample.

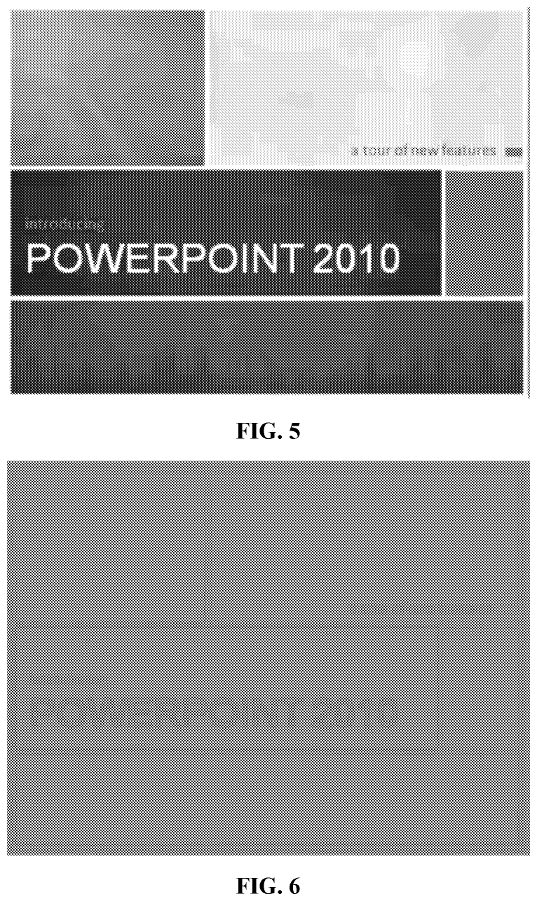

It should be noted that the size of the first reconstructed image and the first edge image is the same, and the first edge image includes edge information of each reconstructed sample in the first reconstructed image. The reconstructed sample may be a reconstructed sample of the luma component, and the first edge image is an edge image of the luma component. The reconstructed sample may also be a reconstructed sample of the chroma component, and the first edge image is an edge image of the chroma component. FIG. 5 is a schematic diagram of a reconstructed image according to an embodiment of the present disclosure, and FIG. 6 is a schematic diagram of an edge image according to an embodiment of the present disclosure.

In some embodiments, the edge information may be a type of binarized data used to represent object edges in an image. In other embodiments, the edge information may further include edge strength, which represents not only the edges of the object but also the edge strength of the object in the image.

In some embodiments, the method further includes: acquiring a second reconstructed image of a frame in which the current block is located; performing edge detection on the second reconstructed image based on a first edge detection operator to determine a second edge image. The operation of acquiring a first edge image of the current block includes: acquiring the first edge image of the current block from the second edge image.

In some embodiments, the operation of acquiring the second reconstructed image of the frame in which the current block is located includes: acquiring an initial reconstructed image of the frame in which the current block is located; and taking the initial reconstructed image as the second reconstructed image; or, performing deblocking filtering on the initial reconstructed image to obtain the second reconstructed image, or, performing sample adaptive offset on the initial reconstructed image to obtain the second reconstructed image, or, performing deblocking filtering and sample adaptive offset on the initial reconstructed image to obtain the second reconstructed image. That is, when the encoding side performs in-loop filtering on the reconstructed image based on an image or a block, an edge image including edge information of all reconstructed samples of the current block is determined by performing edge detection on the reconstructed image. The reconstructed image may be an initial reconstructed image composed of reconstructed blocks, or may be another type of image such as an image after deblocking filtered or an image after sample adaptive offset.

In some embodiments, the method further includes: traversing an edge detection operator list to obtain a candidate edge detection operator as a first edge detection operator; if the minimum cost value is the first cost value, determining that the neural network-based in-loop filtering technique is applied; determining an index value of an optimal edge detection operator corresponding to the minimum cost value; and encoding the index value of the optimal edge detection operator. That is, the encoding side can use multiple existing edge detection operators to perform edge detection, make encoding decisions, decide the optimal edge detection operator based on the minimum cost value, encode an index value of the optimal edge detection operator, and write the encoded information into a bitstream, and transmit the bitstream to the decoding side. The decoder selects the optimal edge detection operator based on the index value of the parsed edge detection operator, and performs edge detection on the reconstructed image.

In other embodiments, the first edge detection operator is a preset edge detection operator.

In the embodiment of the present disclosure, the first edge detection operator may be one of: a Sobel operator, a Laplacian operator, a Roberts operator, or the like.

Exemplarily, the first edge detection operator is a Sobel operator.

The operation of performing edge detection on the second reconstructed image based on the first edge detection operator to determine the second edge image includes: detecting gradient information of the second reconstructed image to determine lateral gradient information and longitudinal gradient information; and determining the second edge image based on the lateral gradient information and the longitudinal gradient information.

The detection principle of the Sobel operator is as follows:

$$Gx = [ \begin{matrix}- 1 & 0 & + 1 \\ - 2 & 0 & + 2 \\ - 1 & 0 & + 1\end{matrix} ] * A , Gy = [ \begin{matrix}+ 1 & + 2 & + 1 \\ 0 & 0 & 0 \\ - 1 & - 2 & - 1\end{matrix} ] * A$$

As illustrated in the above formula, A represents the edge information image to be extracted, Gx is the lateral gradient information, and Gy is the longitudinal gradient information. After extracting gradient information from all sample points of image A, the sum of lateral/horizontal and longitudinal/vertical gradient information is derived as follows:

$$G = \sqrt{G {x}^{2} + G {y}^{2}}$$

In some embodiments, the operation of determining the second edge image based on the lateral gradient information and the longitudinal gradient information includes: determining a gradient absolute value of the reconstructed sample based on a lateral gradient in the lateral gradient information and a longitudinal gradient in the longitudinal gradient information of the reconstructed sample; and taking the gradient absolute value as the edge information of the reconstructed sample.

In order to reduce computational complexity and the like, instead of the above equation, G may be calculated by calculating the sum of the absolute values of Gx and Gy. The specific expression is as follows:

$$G = \vert Gx \vert + \vert Gy \vert$$

In some embodiments, the method further includes: acquiring a second reconstructed image of a frame in which the current block is located; performing edge detection on the second reconstructed image based on the first edge detection operator to determine the second edge image; and performing denoising processing on the second edge image to obtain the denoised second edge image. Further, the first edge image of the current block is obtained from the denoised second edge image.

Exemplarily, the operation of performing denoising processing on the second edge image to obtain the denoised second edge image includes: retaining the edge strength of the first reconstructed sample if the edge strength of the first reconstructed sample is greater than or equal to a first threshold; and if the edge strength of the second reconstructed sample is less than the first threshold, the edge strength of the second reconstructed sample is set to zero.

It should be noted that the edge image is calculated based on the edge detection operator or the like. Since the extremely low gradient amplitude contributes little to the enhancement of the high-frequency information or is noise, the noise may be filtered out by the first threshold to obtain an updated edge image.

The first threshold may be a preset specific threshold value, or may be determined based on the edge strength characteristics of the current edge image. In some embodiments, the method further includes: determining an average value of edge strengths of all reconstructed samples in the second edge image; and determining the first threshold based on the average value.

In some embodiments, the first edge image and the second edge image are edge images of chroma component, the method further includes: determining a second edge image of luma component and a second edge image of chroma component; and determining a final second edge image of chroma component based on the second edge image of the luma component and the second edge image of the chroma component.

It should be noted that since the number of samples of the chroma component is usually small, the edge contour of the chroma component is not as clear as the edge contour of the luma component, and for the edge image of the chroma component, the determination of the edge image of the chroma component may be guided based on the edge image of the luma component, thereby improving the quality of the edge image of the chroma component.

For example, the second edge image of the luma component is downsampled to obtain the downsampled edge image of the luma component, and the average edge strength of each sample of the downsampled edge image of the luma component and the edge image of the chroma component is calculated to obtain the final second edge image of the chroma component.

In other embodiments, the second edge image of the luma component may also be directly used as the second edge image of the chroma component.

At block S404: inputting the first reconstructed image and the first edge image into the neural network-based in-loop filtering model to obtain a filtered image of the current block.

It should be noted that video content often has strong edge information or high-frequency information, and this part is a very important part of subjective vision, and it is also a part where it is difficult to obtain gain. By inputting the edge images as new side information into the in-loop filtering model, sample-level edge information is provided for the network, the learning of filtering strength is adjusted at the sample level, and the filtering effect is improved. If it is determined based on the first indication information that the neural network-based in-loop filtering technique is not applied to the current block, another filtering technique is applied to the first reconstructed image.

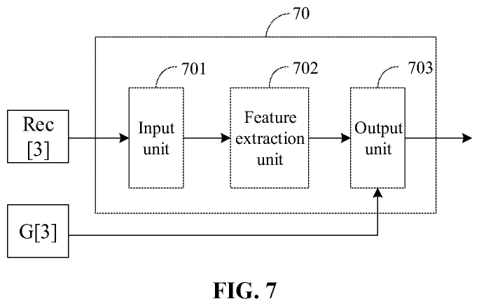

In some embodiments, FIG. 7 is a schematic diagram of a composition structure of an in-loop filtering model according to an embodiment of the present disclosure. The neural network-based in-loop filtering model 70 includes: an input unit 701, a feature extraction unit 702, and an output unit 703. The first reconstructed image Rec and the first edge image G are input into the input unit 701, and are then processed by the feature extraction unit 702 and the output unit 703, to output the filtered image.

In another embodiment, the first reconstructed image Rec is input into the input unit 701, and is then processed by the feature extraction unit 702, the feature extraction unit 702 inputs the output feature information of the first reconstructed image to the output unit 703. The first edge image G is input into the output unit 703, and the output unit 703 processes the feature maps of the first edge image and the first reconstructed image to output the filtered image.

In still other embodiments, the first edge image G and the first reconstructed image Rec are input into the input unit 701, and the first edge image G is input into the output unit 703 at the same time, and the output unit 703 processes the feature information of the first edge image and the first reconstructed image to output the filtered image.

It should be noted that the processing of edge information in the in-loop filtering model may be different from other input information. Since the edge information represents high-frequency information, it exerts a more significant effect at the posterior stage of the in-loop filtering model. The edge information is directly input into the posterior output unit of the in-loop filtering model, and the image reconstruction is performed on the edge information from original input to ensure the auxiliary effect of the edge information on the in-loop filtering.

In some embodiments, the method further includes the following operations. At least one of a predicted image, boundary strength information, slice type information, or quantization information of the current block is acquired. At least one of the predicted image, the boundary strength information, the slice type information, or the quantization information are simultaneously input into the neural network-based in-loop filtering model to obtain the filtered image of the current block.

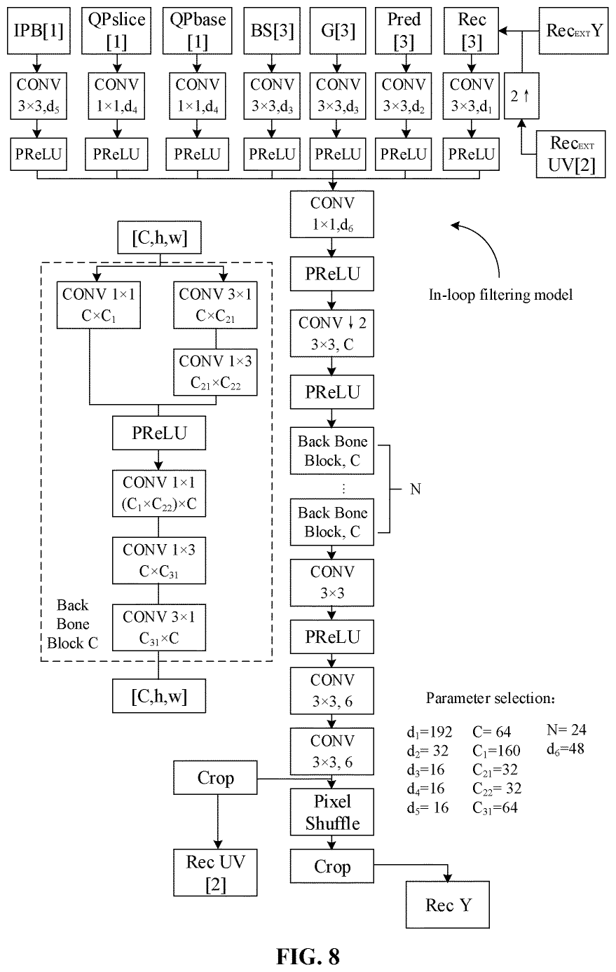

FIG. 8 is a schematic diagram of the composition structure of another in-loop filtering model according to the embodiment of the present disclosure. As illustrated in FIG. 8, the input part mainly includes reconstruction sample rec, prediction sample pred, boundary information G, boundary strength information BS, slice type information IPB, quantization parameter OP, and the like. Reconstructed samples and predicted samples can provide good residual information. Here, the boundary strength information may be understood as the strength information detected based on the deblocking filter. The boundary strength can help the neural network-based in-loop filtering tool to learn the ability of the deblocking filter. The mode information indicates that the coding block in which the sample is located is intra prediction I, unidirectional inter prediction P, and bi-directional inter prediction B. Finally, the quantization parameter part further includes a basic quantization value BaseQP or a frame-level quantization value SliceQP. The mode information and the quantization information adjust the learning of the filtering strength from the local block level and the global frame level respectively. Generally, the neural network-based in-loop filtering tool is a single network model, that is, a single model is used to process different color components and different frame types. Therefore, the input information for the single network model also includes the different color components of the input portion, such as the reconstruction sample recY and the prediction sample predY of the luma component, as well as the reconstruction sample recUV and the prediction sample predUV of the chroma component in the YUV domain.

For the output part, based on the above description of the input part, if the input includes different color components, the output part also includes different color components, that is, the filtered sample filteredRecY of the luma component and the filtered sample filterRecUV of the chroma component.

In some embodiments, the method further includes the following operations. In a model training stage, the edge detection is performed on a training image based on multiple edge detection operators, to obtain multiple edge images. A training sample set is constructed based on the training image, the multiple edge images and a truth image. The neural network-based in-loop filtering model is trained by using the training sample set to obtain the trained in-loop filtering model. It should be noted that in the training stage of the model, different types of operators may be used to calculate the edge images, and the multiple edge images may be used to construct the training data set, and the training data set may be used for model training to improve the robustness of the model.

At block S405: performing cost calculation based on the original image and the filtered image of the current block to determine the first cost value.

In some embodiments, the method further includes the following operations. Residual scaling parameters are determined for the current block. A sample residual of the current block is determined based on the reconstructed samples in the first reconstructed image and the reconstructed samples in the filtered image. The sample residual is scaled based on the residual scaling parameter to obtain the scaled residual of the current block. A target reconstructed image of the current block is determined based on the first reconstructed image and the scaled residual. Cost calculation is performed based on the original image of the current block and the target reconstructed image to determine the second cost value. It is determining whether a residual scaling technique is applied to the current block based on the second cost value, and second indication information is set and encoded, and the obtained encoded bits are written into the bitstream.

In some embodiments, the second indication information includes at least one of: a flag of a frame-level syntax element for indicating whether a residual scaling technique is adapted for the frame in which the current block is located; a flag of a slice-level syntax element for indicating whether a residual scaling technique is applied to the slice on which the current block is located; a flag of the coding tree unit-level syntax element for indicating whether the residual scaling technique is applied to the coding tree unit where the current block is located.

In some embodiments, the operation of determining the residual scaling parameter of the current block includes: calculating the residual scaling parameter based on the original sample, the reconstructed sample before filtering, and the post-filtering reconstructed sample; to determine the residual scaling parameter of the current block. The method further includes: determining, based on the second cost value, that a residual scaling technique is applied to the current block, and encoding the residual scaling parameter.

In some embodiments, the operation of determining residual scaling parameters of the current block includes: traversing a residual scaling parameter list to determine residual scaling parameters of the current block. The method further includes: determining, based on the second cost value, that a residual scaling technique is applied to the current block, determining an index value of an optimal residual scaling parameter, and encoding the index value of the optimal residual scaling parameter.

In some embodiments, the method further includes: encoding the third indication information. The third indication information may be an index value of the residual scaling parameter, which is denoted as scaleIdx. When scaleIdx is 0, the encoded residual scaling parameter is determined, and when scaleIdx is not 0, the index value of the residual scaling parameter is determined based on scaleIdx.

Further, the method further includes: performing sample classification on the current block based on the first edge image to determine a sample type of each sample in the current block. One sample type corresponds to one residual scaling parameter. That is, the edge images may not only be used as new side information of the in-loop filtering model, but also provide sample-level edge information for the network, so as to adjust the learning of filtering strength at the sample level, and improve the filtering effect. Edge images may also be used as sample classification information, classify and scale the sample parameters, and improve the accuracy of scaled residuals, thereby improving the quality of reconstructed images and coding efficiency.

At block S406: determining whether a neural network-based in-loop filtering technique is applied to the current block based on the first cost value, and setting first indication information of the current block.

At block S407: encoding the first indication information, and writing the obtained encoded bits into the bitstream.

The first indication information indicates whether or not a neural network-based in-loop filtering technique is applied to the current block. The current block may be any kind of neural network-based in-loop filtering processing unit. In some embodiments, the current block may be a current coding tree unit. In other embodiments, the current block may also be a current image block obtained by other partitioning methods. In other embodiments, the current block may also be a current frame.

It should also be noted that the current block includes at least a first color component and a second color component. For the first color component of the current block, the block may be referred to as a first color component block for short. Moreover, when the first color component is a luma component, the first color component block may also be referred to as a luma block. Similarly, for the second color component of the current block, the block may be referred to as the second color component block for short. Moreover, when the second color component is a chroma component, the second color component block may also be referred to as a chroma block.

In some embodiments, the first indication information includes a flag of a first syntax element and a flag of a second syntax element. The flag of the first syntax element indicates whether the neural network-based in-loop filtering technique is allowed to be applied to the image unit where the current block is located, and the flag of the second syntax element indicates whether the neural network-based in-loop filtering technique is applied to the current block.

In some embodiments, the operation of decoding the bitstream to determine the first indication information includes: decoding the bitstream to determine a flag of a first syntax element, which is denoted as sps_nnlf_enable_flag; if the flag of the first syntax element indicates that a neural network-based in-loop filtering technique is allowed to be applied to the current image sequence, decoding the bitstream to determine flag information of the second syntax element; if the flag of the first syntax element indicates that the neural network based in-loop filtering technique is not allowed to be applied to the current image sequence, determining that the neural network in-loop filtering based technique is not applied to the current sequence, and another filtering technique is applied to the first reconstructed image of the current block.

In some embodiments, when the current block is a coding tree unit, the flag of the second syntax element includes: a flag of a frame-level second syntax element for indicating whether a neural network-based in-loop filtering technique is applied to the frame in which the current block is located; and a flag of the coding tree unit-level second syntax element for indicating whether a neural network-based in-loop filtering technique is applied to the coding tree unit where the current block is located.

It should be noted that the flag of the frame-level second syntax element may be represented by sh_nnlf_flag, and the flag of the coding tree unit-level second syntax element may be represented by ctb_nnlf_flag, and if sh_nnlf_flag is true, the flag bit ctb_nnlf_flag for enabling the neural network-based in-loop filtering of all coding tree units in the current frame is parsed based on sh_nnlf_flag. If ctb_nnlf_flag is true, the neural network-based in-loop filtering technique is applied to the current coding tree unit, and if false, the neural network-based in-loop filtering technique is not applied.

If sh_nnlf_flag is false, the flag bit ctb_nnlf_flag for enabling the neural network-based in-loop filtering of all coding tree units in the current frame is false, that is, all coding tree units in the current frame do not use this technique.

In other embodiments, the current block is not a coding tree unit, and the flag of the second syntax element may further include a flag of a block-level second syntax element for indicating whether the neural network-based in-loop filtering technique is applied to the current block.

On the basis of the above-described embodiments, the encoding method according to the embodiment of the present disclosure will be further described with an example.

In this embodiment, at the encoding side, the encoder obtains a reconstructed image after prediction, transformation, quantization, inverse quantization and inverse transformation, and starts the in-loop filtering to improve image quality. The flag bit sps_nnlf_enable_flag for allowing the neural network-based in-loop filtering tool to be applied is parsed, and if this flag bit is true, the tool is allowed to be applied; otherwise, the use of the tool is not allowed.

In operation 1, if this flag bit for allowing the neural network-based in-loop filtering tool to be applied is true, then perform 2; otherwise, skip 2 and execute 3 directly.

In operation 2, the reconstructed sample image of the input network model is acquired, the corresponding horizontal gradient Gx and vertical gradient Gy are calculated for each sample of the reconstructed sample image by using the Sobel operator, and the square root of the sum of the squares of Gx and Gy are calculated to derive the gradient amplitude of each sample point, that is, an edge image has the same size as the reconstructed sample image. The value of the gradient amplitude is related to the rate of pixel value variation in the image. In edge detection, the gradient amplitude may provide the strength information of the edge positions. It should be noted that the edge image is calculated based on the Sobel operator or the Laplace operator, and the like, in which the extremely low gradient amplitude contributes little to the enhancement of the high-frequency information or is noise, in some embodiments, a threshold value therefore may be preset to filter out the noise to obtain an updated edge image. Exemplarily, the mean value Gavg of all gradient amplitude samples in the edge image is calculated to obtain an update edge image. For all samples in the edge image whose gradient amplitude samples are larger than Gavg, the gradient amplitude is retained; otherwise set it to zero.

The network model is initialized based on the preset parameters, the reconstruction sample rec, the prediction sample pred, the boundary strength BS, the mode information IPB, the quantization information BaseQP and SliceQP, and the edge image of the current coding tree unit region are acquired, and these information are input into the network model for inference calculation.

The filtered reconstructed sample filteredRec is obtained upon the inference of the network model.

If the residual scaling technique is applied to the current frame or the current coding tree unit, the residual scaling parameters are calculated based on the original image, the reconstructed image and the filtered image. The encoding side calculates the rate-distortion cost of the obtained parameters and the default parameters, and selects the optimal parameter. The parameter is dot-multiplied by the residual between the filtered reconstructed sample filteredRec and the pre-filtered reconstructed sample rec, and then the scaled residual is added back to the pre-filtered reconstructed sample rec to obtain the output sample output. If the residual scaling technique is not applied to the current frame or current coding tree unit, the filtered reconstructed sample filteredRec is directly taken as the output sample output.

In operation 3, the encoding side continues to operate other in-loop filtering techniques.

In operation 4, after executing all the in-loop filtering tools, the final output image is obtained and the bitstream information is output.

By adopting the above technical scheme, at the encoding side, the edge image is input as newly added side information into the in-loop filtering model, which provides the sample-level edge information for the network, the learning of the filtering strength is adjusted at the sample level, the filtering effect is improved, and thus, the quality of the reconstructed image and the coding performance are improved.

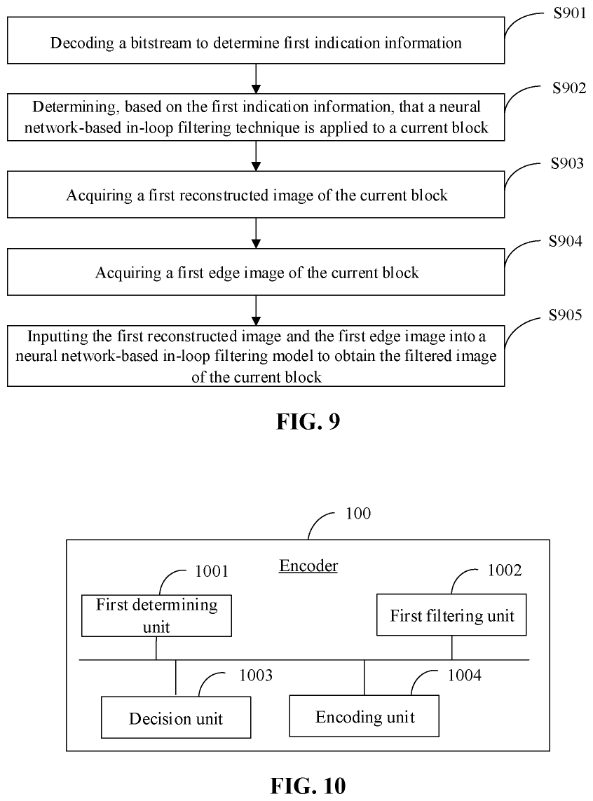

In still another embodiment of the present disclosure, FIG. 9 illustrates a schematic flow diagram of a decoding method according to the embodiment of the present disclosure. As illustrated in FIG. 9, the method may include the operations S901, S902, S903 and S904.

At block S901: decoding the bitstream to determine first indication information.

It should be noted that the first indication information indicates whether or not a neural network-based in-loop filtering technique is applied to the current block. The current block may be any kind of the neural network-based in-loop filtering processing unit. In some embodiments, the current block may be a current coding tree unit. In other embodiments, the current block may also be a current image block obtained by other partitioning methods. In other embodiments, the current block may also be a current frame.

It should also be noted that the current block includes at least a first color component and a second color component. For the first color component of the current block, the block may be referred to as a first color component block for short. Moreover, when the first color component is the luma component, the first color component block may also be referred to as a luma block. Similarly, for the second color component of the current block, the block may be referred to as the second color component block for short. Moreover, when the second color component is the chroma component, the second color component block may also be referred to as a chroma block.

In some embodiments, the first indication information includes a flag of a first syntax element and a flag of a second syntax element. The flag of the first syntax element indicates whether the neural network-based in-loop filtering technique is allowed to be applied to the image unit where the current block is located, and the flag of the second syntax element indicates whether the neural network-based in-loop filtering technique is applied to the current block.

In some embodiments, the operation of decoding the bitstream to determine the first indication information includes: decoding the bitstream to determine a flag of a first syntax element, which is denoted as sps_nnlf_enable_flag; if the flag of the first syntax element indicates that a neural network-based in-loop filtering technique is allowed to be applied to the current image sequence, decoding the bitstream to determine the flag information of the second syntax element; if the flag of the first syntax element indicates that the neural network-based in-loop filtering technique is not allowed to be applied to the current image sequence, determining that the neural network-based in-loop filtering technique is not applied to the current sequence, and another filtering technique is applied to the first reconstructed image of the current block.

In some embodiments, when the current block is a coding tree unit, the flag of the second syntax element includes: a flag of the frame-level second syntax element for indicating whether a neural network-based in-loop filtering technique is applied to the frame in which the current block is located. The flag of the coding tree unit-level second syntax element indicates whether a neural network-based in-loop filtering technique is applied to the coding tree unit where the current block is located.

The flag of the frame-level second syntax element may be represented by sh_nnlf_flag, the flag of the coding tree unit-level second syntax element may be represented by ctb_nnlf_flag, and if sh_nnlf_flag is true, the flag bit ctb_nnlf_flag for enabling the neural network-based in-loop filtering of all coding tree units in the current frame is parsed based on sh_nnlf_flag. If ctb_nnlf_flag is true, the neural network-based in-loop filtering technique is applied to the current coding tree unit, and if false, the neural network-based in-loop filtering technique is not applied.

If sh_nnlf_flag is false, the flag bit ctb_nnlf_flag for enabling the neural network-based in-loop filtering of all coding tree units in the current frame is false, that is, all coding tree units in the current frame do not use this technique.

In other embodiments, the current block is not a coding tree unit, and the flag of the second syntax element may further include a flag of a block-level second syntax element for indicating whether a neural network-based in-loop filtering technique is applied to the current block.

At block S902: determining, based on the first indication information, that the neural network-based in-loop filtering technique is applied to the current block.

It should be noted that if it is determined from the first indication information that the neural network-based in-loop filtering technique is applied to the current block, the edge image is input as the newly added side information into the in-loop filtering model, which provides sample-level edge information for the network, the learning of the filtering strength is adjusted at the sample level, and the filtering effect is improved. If it is determined based on the first indication information that the neural network-based in-loop filtering technique is not applied to the current block, another filtering technique is applied to the first reconstructed image of the current block.

At block S903: acquiring a first reconstructed image of the current block. The first reconstructed image includes a reconstructed sample of the current block.

It should be noted that the reconstructed sample may be a reconstructed sample of the luma component, and the first reconstructed image is a reconstructed image of the luma component. The reconstructed sample may also be a chroma reconstructed sample, and the first reconstructed image is a reconstructed image of the chroma component.

In some embodiments, the operation of acquiring the first reconstructed image of the current block includes: acquiring an initial reconstructed image of a frame in which the current image is located. A first reconstructed image of the current block is obtained from the initial reconstructed image. That is, the decoding side parses the bitstream to obtain a quantized coefficient matrix, performs inverse quantization and inverse transformation on the quantized coefficient matrix to obtain a residual block, adds the prediction block and the residual block to obtain a reconstructed block which forms a reconstructed image, and performs in-loop filtering on the reconstructed image based on the image or the block to obtain a decoded image.

In other embodiments, deblocking filtering is performed on the initial reconstructed image, and a first reconstructed image of the current block is obtained from the filtered image. Alternatively, sample adaptive offset is performed on the initial reconstructed image, and a first reconstructed image of the current block is obtained from the compensated image. Alternatively, the deblocking filtering and the sample adaptive offset are performed on the initial reconstructed image, and the first reconstructed image of the current block is obtained from the compensated image. That is, the decoding side performs in-loop filtering on the reconstructed image based on the image or the block, and the reconstructed image input into the in-loop filtering model may be other images such as deblocking filtered images or sample adaptive offset images.

At block S904: acquiring a first edge image of the current block. The first edge image includes edge information of the reconstructed sample.

It should be noted that the size of the first reconstructed image is the same as that of the first edge image, and the first edge image includes edge information of each reconstructed sample in the first reconstructed image. The reconstructed sample may be a reconstructed sample of the luma component, and the first edge image is an edge image of the luma component. The reconstructed sample may also be a chroma reconstructed sample, and the first edge image is an edge image of the chroma component. FIG. 5 is a schematic diagram of a reconstructed image according to an embodiment of the present disclosure, and FIG. 6 is a schematic diagram of an edge image according to an embodiment of the present disclosure.

In some embodiments, the edge information may be the binarized data used to represent the edges of the object in the image. In other embodiments, the edge information may further include edge strength representing not only the edges of the object but also the edge strength of the object in the image.

In some embodiments, the method further includes: acquiring a second reconstructed image of a frame in which the current block is located; performing edge detection on the second reconstructed image based on the first edge detection operator to determine a second edge image. The operation of acquiring the first edge image of the current block includes: acquiring the first edge image of the current block from the second edge image.

In some embodiments, the operation of acquiring the second reconstructed image of the frame in which the current block is located includes: acquiring an initial reconstructed image of the frame in which the current block is located; taking the initial reconstructed image as a second reconstructed image; alternatively, performing deblocking filtering on the initial reconstructed image to obtain a second reconstructed image; alternatively, performing sample adaptive offset on the initial reconstructed image to obtain the second reconstructed image; alternatively, performing both the deblocking filtering and the sample adaptive offset on the initial reconstructed image to obtain the second reconstructed image. That is, when the decoding side performs in-loop filtering on the reconstructed image based on the image or the block, the decoding side determines an edge image including all reconstructed sample edge information of the current block by performing edge detection on the reconstructed image, the reconstructed image may constitute an initial reconstructed image of the reconstructed block, or may be another image such as a deblocking filtered image or an image after sample adaptive offset.

In some embodiments, the method further includes: decoding the bitstream to determine an index value of a first edge detection operator, and determining a first edge detection operator from an edge detection operator list based on the index value of the first edge detection operator. That is, the encoding side may use multiple existing edge detection operators to perform the edge detection, make encoding decisions, decide the optimal edge detection operator based on the minimum cost value, encode an index value of the optimal edge detection operator, and write the encoded information into a bitstream, and transmit the bitstream to the decoding side. The decoder selects the optimal edge detection operator based on the index value of the parsed edge detection operator, and performs edge detection on the reconstructed image.

In other embodiments, the first edge detection operator is a preset edge detection operator.

In the embodiment of the present disclosure, the first edge detection operator may be one of: a Sobel operator, a Laplacian operator, a Roberts operator, or the like.

Exemplarily, the first edge detection operator is a Sobel operator.

The operation of performing the edge detection on the second reconstructed image based on the first edge detection operator to determine the second edge image includes: detecting gradient information of the second reconstructed image to determine lateral gradient information and longitudinal gradient information; and determining the second edge image based on the lateral gradient information and the longitudinal gradient information.

The detection principle of the Sobel operator is as follows:

$$Gx = [ \begin{matrix}- 1 & 0 & + 1 \\ - 2 & 0 & + 2 \\ - 1 & 0 & + 1\end{matrix} ] * A , Gy = [ \begin{matrix}+ 1 & + 2 & + 1 \\ 0 & 0 & 0 \\ - 1 & - 2 & - 1\end{matrix} ] * A$$

As illustrated in the above formula, A represents the edge information image to be extracted, Gx is the lateral gradient information, and Gy is the longitudinal gradient information. After extracting gradient information from all sample points of image A, the sum of lateral/horizontal and longitudinal/vertical gradient information is derived as follows:

$$G = \sqrt{G {x}^{2} + G {y}^{2}}$$

In some embodiments, the operation of determining the second edge image based on the lateral gradient information and the longitudinal gradient information includes: determining a gradient absolute value of the reconstructed sample based on a lateral gradient in the lateral gradient information and a longitudinal gradient in the longitudinal gradient information of the reconstructed sample; and taking the gradient absolute value as the edge information of the reconstructed sample.

In order to reduce computational complexity and the like, instead of the above equation, G may be calculated by calculating the sum of the absolute values of Gx and Gy. The specific expression is as follows:

$$G = \vert Gx \vert + \vert Gy \vert$$

In some embodiments, the method further includes: acquiring a second reconstructed image of a frame in which the current block is located; performing edge detection on the second reconstructed image based on the first edge detection operator to determine the second edge image; performing denoising processing on the second edge image to obtain the denoised second edge image. Further, the first edge image of the current block is obtained from the denoised second edge image.

Exemplarily, the operation of performing denoising processing on the second edge image to obtain the denoised second edge image includes: retaining the edge strength of the first reconstructed sample if the edge strength of the first reconstructed sample is greater than or equal to a first threshold. If the edge strength of the second reconstructed sample is less than the first threshold, the edge strength of the second reconstructed sample is set to zero.

It should be noted that the edge image is calculated based on the edge detection operator or the like. Since the extremely low gradient amplitude contributes little to the enhancement of the high-frequency information or is noise, the noise may be filtered out by the first threshold to obtain an updated edge image.

The first threshold may be a preset specific threshold value, or may be determined based on the edge strength characteristics of the current edge image. In some embodiments, the method further includes: determining an average value of edge strengths of all reconstructed samples in the second edge image; and determining the first threshold based on the average value.

In some embodiments, the first edge image and the second edge image are edge images of chroma component, the method further includes: determining a second edge image luma component and a second edge image of chroma component; and determining a final second edge image of chroma component based on the second edge image of the luma component and the second edge image of the chroma component.

It should be noted that since the number of samples of the chroma component is usually small, the edge contour of the chroma component is not as clear as the edge contour of the luma component, and for the edge image of the chroma component, the determination of the edge image of the chroma component may be guided based on the edge image of the luma component, thereby improving the quality of the edge image of the chroma component.

For example, the second edge image of the luma component is downsampled to obtain the downsampled edge image of the luma component, and the average edge strength of each sample of the downsampled edge image of the luma component and the edge image of the chroma component is calculated to obtain the final second edge image of the chroma component.

In other embodiments, the second edge image of the luma component may also be directly used as the second edge image of the chroma component.

At block S905: inputting the first reconstructed image and the first edge image into the neural network-based in-loop filtering model to obtain the filtered image of the current block.

It should be noted that video content often has strong edge information or high-frequency information, and this part is a very important part of subjective vision, and it is also a part where it is difficult to obtain gain. By inputting the edge images as new side information into the in-loop filtering model, sample-level edge information is provided for the network, the learning of filtering strength is adjusted at the sample level, and the filtering effect is improved. If it is determined based on the first indication information that the neural network-based in-loop filtering technique is not applied to the current block, another filtering technique is applied to the first reconstructed image.

In some embodiments, FIG. 7 is a schematic diagram of a composition structure of an in-loop filtering model according to an embodiment of the present disclosure. The neural network-based in-loop filtering model 70 includes: an input unit 701, a feature extraction unit 702, and an output unit 703. The first reconstructed image Rec and the first edge image G are input into the input unit 701, and are then processed by the feature extraction unit 702 and the output unit 703, to output the filtered image.

In another embodiment, the first reconstructed image Rec is input into the input unit 701, and is then processed by the feature extraction unit 702, the feature extraction unit 702 inputs the output feature information of the first reconstructed image to the output unit 703. The first edge image G is input into the output unit 703, and the output unit 703 processes the feature maps of the first edge image and the first reconstructed image to output the filtered image.

In still other embodiments, the first edge image G and the first reconstructed image Rec are input into the input unit 701, and the first edge image G is input into the output unit 703 at the same time, and the output unit 703 processes the feature information of the first edge image and the first reconstructed image to output the filtered image.

It should be noted that the processing of edge information in the in-loop filtering model may be different from other input information. Since the edge information represents high-frequency information, it exerts a more significant effect at the posterior stage of the in-loop filtering model. The edge information is directly input into the posterior output unit of the in-loop filtering model, and the image reconstruction is performed on the edge information from original input to ensure the auxiliary effect of the edge information on the in-loop filtering.

In some embodiments, the method further includes the following operations. At least one of a predicted image, boundary strength information, slice type information, or quantization information of the current block is acquired. At least one of the predicted image, the boundary strength information, the slice type information, or the quantization information are simultaneously input into the neural network-based in-loop filtering model to obtain the filtered image of the current block.

In some embodiments, the method further includes the following operations. In a model training stage, the edge detection is performed on a training image based on multiple edge detection operators, to obtain multiple edge images. A training sample set is constructed based on the training image, the multiple edge images and a truth image. The neural network-based in-loop filtering model is trained by using the training sample set to obtain the trained in-loop filtering model. It should be noted that in the training stage of the model, different types of operators may be used to calculate the edge images, and the multiple edge images may be used to construct the training data set, and the training data set may be used for model training to improve the robustness of the model.

In some embodiments, the method further includes: decoding the bitstream to determine second indication information; determining, based on the second indication information, that a residual scaling technique is applied to the current block; decoding the bitstream to determine a residual scaling parameter of the current block; determining a sample residual of the current block based on the reconstructed samples in the first reconstructed image and the reconstructed samples in the filtered image; scaling the sample residual based on the residual scaling parameter to obtain the scaled residual of the current block; determining a target reconstructed image of the current block based on the first reconstructed image and the scaled residual.

In some embodiments, the second indication information includes at least one of: a flag of a frame-level syntax element for indicating whether a residual scaling technique is applied to the frame in which the current block is located; a flag of a slice-level syntax element for indicating whether a residual scaling technique is applied to the slice on which the current block is located; a flag of the coding tree unit-level syntax element for indicating whether the residual scaling technique is applied to the coding tree unit where the current block is located.

In some embodiments, the operation of decoding the bitstream to determine residual scaling parameters of the current block includes: decoding the bitstream to determine third indication information; determining a decoding residual scaling parameter based on the third indication information, decoding the bitstream to determine the residual scaling parameter of the current block; determining an index value of the decoded residual scaling parameter based on the third indication information, decoding the bitstream to determine the index value of the residual scaling parameter; determining the residual scaling parameter from the residual scaling parameter list based on the index value of the residual scaling parameter.

In some embodiments, the third indication information may be an index value of the residual scaling parameter, which is denoted as scaleIdx. When scaleIdx is 0, the decoding residual scaling parameter is determined; when scaleIdx is not 0, the index value of the residual scaling parameter is determined based on scaleIdx.

In some embodiments, the operation of decoding the bitstream to determine residual scaling parameters of the current block includes: decoding the bitstream to obtain at least two residual scaling parameters of the current block. The operation of scaling the sample residuals based on the residual scaling parameters to obtain the scaled residuals of the current block including: classifying and scaling the sample residuals based on at least two residual scaling parameters to obtain the scaled residuals of the current block.

Further, the method further includes: performing sample classification on the current block based on the first edge image to determine a sample type of each sample in the current block. One sample type corresponds to one residual scaling parameter. That is, the edge images may not only be used as new side information of the in-loop filtering model, but also provide sample-level edge information for the network, so as to adjust the learning of filtering strength at the sample level, and improve the filtering effect. Edge images may also be used as sample classification information, classify and scale the sample parameters, and improve the accuracy of scaled residuals, thereby improving the quality of reconstructed images and coding efficiency.

On the basis of the above-described embodiments, the decoding method according to the embodiment of the present disclosure will be further described as an example.

In this embodiment, at the decoding side, the decoding side parses or acquires a flag bit that allows the neural network-based in-loop filtering to be applied, and the flag bit is a sequence level flag bit (sps_nnlf_enable_flag), indicating that the current decoder allows the neural network-based in-loop filtering technique to be applied. If sps_nnlf_enable flag is true, start from operation 1; otherwise, execute from operation 3.

In operation 1, parsing the bitstream to acquire the frame level flag bit sh_nnlf_flag for enabling the neural network-based in-loop filtering technique, and if the flag bit is true, parsing or setting the flag bit ctb_nnlf_flag for enabling the neural network-based in-loop filtering of all coding tree units in the current frame based on the flag bit information. Otherwise, when the flag bit ctb_nnlf_flag for enabling the neural network-based in-loop filtering of all coding tree units in the current frame is false, this technique is not applied to all coding tree units in the current frame.

If sh_nnlf_flag is true, the residual scaling flag bit scaleFlag of the current frame is parsed. Otherwise, scaleFlag defaults to false.

If scaleFlag is true, the residual scaling parameter index scaleIdx is further parsed. If the scaleIdx obtained by parsing indicates that the bitstream needs to be further parsed to obtain the residual scaling parameter, the bitstream is parsed to obtain the residual scaling parameter scale of the color component of the current frame, otherwise, the preset residual scaling parameter scale is obtained based on the index.

In operation 2, the reconstructed sample image of the input network model is acquired, the corresponding horizontal gradient Gx and vertical gradient Gy are calculated for each sample of the reconstructed sample image by using the Sobel operator, and the square root of the sum of the squares of Gx and Gy are calculated to derive the gradient amplitude of each sample point, that is, an edge image has the same size as the reconstructed sample image. It should be noted that the edge image is calculated based on the Sobel operator or the Laplace operator, and the like, in which the extremely low gradient amplitude contributes little to the enhancement of the high-frequency information or is noise, in some embodiments, a threshold value therefore may be preset to filter out the noise to obtain an updated edge image. Exemplarily, the mean value Gavg of all gradient amplitude samples in the edge image is calculated to obtain an update edge image. For all samples in the edge image whose gradient amplitude samples are larger than Gavg, the gradient amplitude is retained; otherwise set it to zero.

In operation 3, the network model is initialized based on the preset parameters.

If the flag bit ctb_nnlf_flag for enabling the neural network-based in-loop filtering of the current coding tree unit is true, the reconstruction sample rec, the prediction sample pred, the boundary strength BS, the mode information IPB, the quantization information BaseQP and SliceQP, and the edge image in the current coding tree unit region are obtained, and these information are input into the network model for inference calculation. The filtered reconstructed sample filteredRec is obtained upon the inference of the network model. If scale Flag is true, the residual scaling factor scale of each color component is acquired based on the parsed residual scaling parameter index scaleIdx. The scale is dot-multiplied by the residual between the filtered reconstructed sample filteredRec and the pre-filtered reconstructed sample rec, and then the scaled residual is added back to the pre-filtered reconstructed sample rec to obtain the output sample output. If the residual scaling technique is not applied to the current frame or current coding tree unit, the filtered reconstructed sample filteredRec is directly taken as the output sample output.

If the flag bit ctb_nnlf_flag foe enabling the neural network-based in-loop filtering of the current coding tree unit is false, the reconstructed sample rec is the output sample output.

In operation 4, the decoding side continues to operate other in-loop filtering techniques.

In operation 5, after executing all the in-loop filtering tools, the final output image is obtained.

By adopting the above technical scheme, at the decoding side, the edge image is input as additional side information into the in-loop filtering model, which provides sample-level edge information for the network, the learning of the filtering strength is adjusted at the sample level, the filtering effect is improved, thereby enhancing the quality of the reconstructed image and the decoding performance.

In still another embodiment of the present disclosure, based on the same inventive concept as the above embodiments, FIG. 10 illustrates a schematic diagram of the composition structure of an encoder according to the embodiment of the present disclosure. As illustrated in FIG. 10, the encoder 100 may include a first determination unit 1001, a first filter unit 1002, a decision unit 1003, and an encoding unit 1004.

The first determination unit 1001 is configured to determine that a current block is allowed for applying a neural network-based in-loop filtering technique.

The first determination unit 1001 is further configured to acquire a first reconstructed image of the current block. The first reconstructed image includes a reconstructed sample of a current block.

The first determination unit 1001 is further configured to acquire a first edge image of the current block. The first edge image includes edge information of the reconstructed sample.

The first filter unit 1002 is configured to input the first reconstructed image and the first edge image into a neural network-based in-loop filtering model to obtain a filtered image of a current block.

The decision unit 1003 is configured to perform cost calculation based on an original image and the filtered image of the current block to determine the first cost value.

The decision unit 1003 is further configured to determine whether the neural network-based in-loop filtering technique is applied to the current block based on the first cost value, and set first indication information of the current block.

The encoding unit 1004 is configured to encode the first indication information and write the obtained encoded bits into a bitstream.

It may be understood that each functional unit of the encoder also performs the encoding method of any one of the foregoing embodiments.

It may be understood that in the embodiments of the present disclosure, the “unit” may be a part of a circuit, a part of a processor, a part of a program or software, etc. Of course, it may also be a module, or may be non-modular. Moreover, in this embodiment, each component may be integrated in one processing unit, each unit may physically exist separately, or two or more units may be integrated in one unit. The above-described integrated unit may be implemented in the form of hardware or software functional modules.

Based on the understanding that the integrated unit may be stored in a computer-readable storage medium if it is implemented in the form of software functional modules and is not sold or used as an independent product, the technical solution of the present embodiment essentially or contributes to the prior art or all or part of the technical solution may be embodied in the form of a software product stored in a storage medium and includes several instructions to cause a computer device (which may be a personal computer, a server, a network device, etc.) or a processor to perform all or part of the operations of the method of the embodiments. The storage medium includes a USB disk, a removable hard disk, a Read Only Memory (ROM), a Random Access Memory (RAM), a magnetic disk, an optical disk, and various media capable of storing program codes.

Accordingly, embodiments of the present disclosure provide a computer-readable storage medium applied to the encoder 100, the computer-readable storage medium stores a computer program, and when the computer program is executed by a first processor, the method of any one of the foregoing embodiments is implemented.

An embodiment of the present disclosure further provides a computer-readable storage medium, and the computer-readable storage medium stores a bitstream generated by the encoding method of any one of the foregoing embodiments. The bitstream is generated by bit encoding based on information to be encoded. The information to be encoded includes at least one of first indication information, second indication information, third indication information, residual information, etc., the first indication information indicates whether a neural network-based in-loop filtering technique is applied to the current block, the second indication information indicates whether the residual scaling technique is applied to a frame in which the current block is located, and the third indication information indicates a decoding residual scaling parameter.

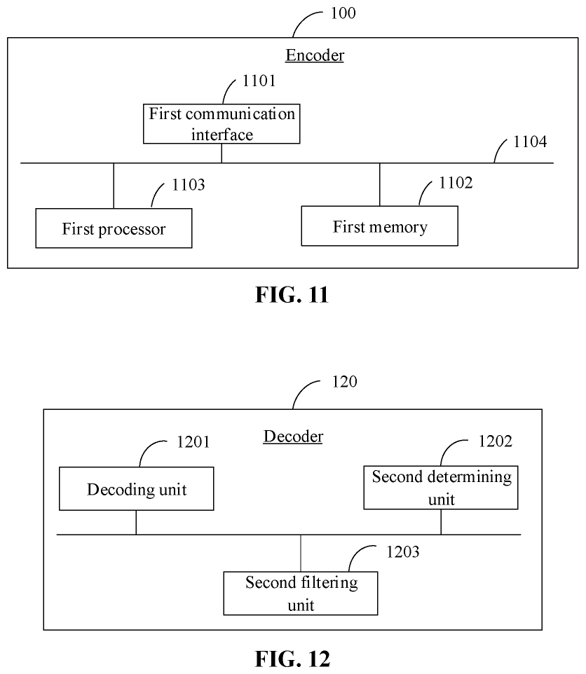

Based on the composition of the encoder 100 and the computer-readable storage medium, FIG. 11 illustrates a schematic diagram of a specific hardware structure of the encoder 100 according to an embodiment of the present disclosure. As illustrated in FIG. 11, the encoder 100 may include: a first communication interface 1101, a first memory 1102, and a first processor 1103. The various components are coupled together by a first bus system 1104. It will be appreciated that the first bus system 1104 is used to enable connected communication among these components. The first bus system 1104 includes a power bus, a control bus, and a status signal bus in addition to a data bus. However, for the sake of clarity of illustration, the various buses are designated as first bus system 1104 in FIG. 11.

The first communication interface 1101 is configured to receive and transmit signals in the process of transmitting and receiving information with other external network elements.

The first memory 1102 is configured to store a computer program that may be executed on the first processor 1103.

The first processor 1103 is configured to, when running the computer program, perform the following operations.

It is determined that the current block is allowed for applying a neural network-based in-loop filtering technique.

A first reconstructed image of the current block is acquired. The first reconstructed image includes a reconstructed sample of the current block.

A first edge image of the current block is acquired. The first edge image includes edge information of the reconstructed sample.

The first reconstructed image and the first edge image are input into a neural network-based in-loop filtering model to obtain a filtered image of the current block.

Cost calculation is performed based on the original image and the filtered image of the current block to determine the first cost value.

It is determined whether the neural network-based in-loop filtering technique is applied to the current block based on the first cost value, and first indication information of the current block is set.

The first indication information is encoded and the obtained encoded bits are written into a bitstream.

It is understood that the first memory 1102 in the embodiment of the present disclosure may be a volatile memory or a non-volatile memory, or may include both volatile and non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), which serves as an external cache. By way of example, but not limitation, many forms of RAM are available, such as Static RAM (SRAM), Dynamic RAM (DRAM), Synchronous DRAM (SDRAM), Double Data Rate SDRAM (DDRSDRAM), Enhanced SDRAM (ESDRAM), Synchlink DRAM (SLDRAM), and Direct Rambus RAM (DRRAM). The first memory 1102 of the systems and methods described herein is intended to include, but is not limited to, these and any other suitable type of memory.

The first processor 1103 may be an integrated circuit chip having signal processing capabilities. In implementation, the operations of the above-described method may be accomplished by an integrated logic circuit of hardware in the first processor 1103 or instructions in the form of software. The above-described first processor 1103 may be a general-purpose processor, a Digital Signal Processor (DSP), an Application Specific Integrated Circuit (ASIC), a Field Programmable Gate Array (FPGA) or other programmable logic device, a discrete gate or transistor logic device, or a discrete hardware component. The methods, operations, and logical block diagrams disclosed in the embodiments of the present disclosure may be implemented or executed. The general purpose processor may be a microprocessor or the processor may be any conventional processor or the like. The operations of the method disclosed in connection with the embodiments of the present disclosure may be directly embodied as execution by the hardware decoding processor, or may be executed by combining hardware and software modules in the decoding processor. The software module may be located in a storage medium mature in the art, such as random access memory, flash memory, read-only memory, programmable read-only memory, or electrically erasable and writable programmable memory, registers, etc. The storage medium is located in the first memory 1102, and the first processor 1103 reads the information in the first memory 1102, and completes the operations of the above method in combination with its hardware.

It will be appreciated that the embodiments described herein may be implemented in hardware, software, firmware, middleware, microcode, or a combination thereof. For hardware implementation, the processing unit may be implemented in one or more Application Specific Integrated Circuits (ASICs), Digital Signal Processors (DSPs), Digital Signal Processing Devices (DSPDs), Programmable Logic Devices (PLDs), Field-Programmable Gate Arrays (FPGAs), general purpose processors, controllers, microcontrollers, microprocessors, other electronic units for performing the functions of the present disclosure, or combinations thereof. For software implementations, the techniques of the present disclosure may be implemented by modules (e.g., procedures, functions, etc.) that perform the functions of the present disclosure. The software code may be stored in a memory and executed by a processor. The memory may be implemented in the processor or external to the processor.

Optionally, as another embodiment, the first processor 1103 is further configured to execute the method of any one of the preceding embodiments when running the computer program.

The present embodiment provides an encoder, in which an edge image is input as additional side information into the in-loop filtering model, which provides sample-level edge information for the network, the learning of the filtering strength is adjusted at the sample level, the filtering effect is improved, thereby enhancing the quality of the reconstructed image and the decoding performance.

In still another embodiment of the present disclosure, based on the same inventive concept as the above embodiments, FIG. 12 illustrates a schematic diagram of the composition structure of a decoder 120 according to the embodiment of the present disclosure. As illustrated in FIG. 12, the decoder 120 may include: a decoding unit 1201, a second determining unit 1202, and a second filter unit 1203.

The decoding unit 1201 is configured to decode the bitstream and determine the first indication information.

The second determination unit 1202 is configured to determine that a neural network-based in-loop filtering technique is applied to the current block based on the first indication information.

The second determination unit 1202 is further configured to acquire a first reconstructed image of the current block. The first reconstructed image includes a reconstructed sample of the current block.

The second determination unit 1202 is further configured to acquire a first edge image of the current block. The first edge image includes edge information of the reconstructed sample.

The second filter unit 1203 is configured to input the first reconstructed image and the first edge image into a neural network-based in-loop filtering model to obtain a filtered image of the current block.

It may be understood that each functional unit of the decoder also performs the decoding method of any one of the foregoing embodiments.

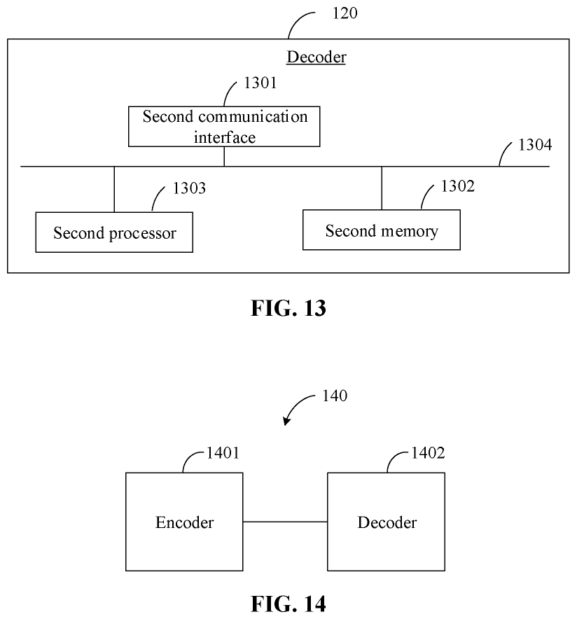

Based on the composition of the decoder 120 and the computer-readable storage medium, FIG. 13 illustrates a schematic diagram of a specific hardware structure of the decoder 120 according to an embodiment of the present disclosure. As illustrated in FIG. 13, the decoder 120 may include: a second communication interface 1301, a second memory 1302, and a second processor 1303. The various components are coupled together by a second bus system 1304. It will be understood that the second bus system 1304 is used to enable connected communication between these components. The second bus system 1304 includes a power bus, a control bus, and a status signal bus in addition to a data bus. However, for clarity of illustration, the various buses are designated as second bus system 1304 in FIG. 13.

The second communication interface 1301 is configured to receive and transmit signals in the process of transmitting and receiving information with other external network elements.

The second memory 1302 is configured to store a computer program that can be executed on the second processor 1303.

The second processor 1303 is configured, when running the computer program, to perform the following operations.

A bitstream is decoded to determine the first indication information.

It is determined, based on the first indication information, that a neural network-based in-loop filtering technique is applied to the current block.

Ac first reconstructed image of the current block is acquired. The first reconstructed image includes a reconstructed sample of the current block.

A first edge image of the current block is acquired. The first edge image includes edge information of the reconstructed sample.

The first reconstructed image and the first edge image are input into the neural network-based in-loop filtering model to obtain the filtered image of the current block.

Optionally, as another embodiment, the second processor 1303 is further configured to execute the method of any of the preceding embodiments when running the computer program.

It may be understood that the second memory 1302 has a hardware function similar to that of the first memory 1102, and the second processor 1303 has a hardware function similar to that of the first processor 1103, and it will not be detailed here.

The present embodiment provides a decoder, in which the edge image is input as additional side information into the in-loop filtering model, which provides sample-level edge information for the network, the learning of the filtering strength is adjusted at the sample level, the filtering effect is improved, thereby enhancing the quality of the reconstructed image and the decoding performance.

In still another embodiment of the present disclosure, FIG. 14 illustrates a schematic structure diagram of a codec system according to the embodiment of the present disclosure. As illustrated in FIG. 14, the codec system 140 may include an encoder 1401 and a decoder 1402.

In an embodiment of the present disclosure, the encoder 1401 may be the encoder described in any one of the preceding embodiments, and the decoder 1402 may be the decoder described in any one of the preceding embodiments.

It should be noted that in the present disclosure, the terms “comprising,” “including,” or any other variation thereof are intended to encompass a non-exclusive inclusion such that a process, method, article, or apparatus including a series of elements includes not only those elements, but also other elements not explicitly listed, or intended to encompass elements inherent to such a process, method, article, or apparatus. Without further limitation, an element defined by the statement “comprising a” does not preclude the presence of additional identical elements in a process, method, article, or apparatus that includes the element.

The serial numbers of the embodiments of the present disclosure described above are for descriptive purposed only, and do not indicate the merits of the embodiments.

The methods disclosed in several method embodiments provided in the present disclosure may be arbitrarily combined without conflict to obtain new method embodiments. The features disclosed in several product embodiments provided in the present disclosure may be arbitrarily combined without conflicting to obtain new product embodiments. The features disclosed in several method or device embodiments provided in the present disclosure may be arbitrarily combined without conflict to obtain a new method or device embodiment.

The forgoing is merely a specific implementation of the present disclosure, but the scope of protection of the present disclosure is not limited thereto, and any person skilled in the art can easily conceive of changes or substitutions within the technical scope disclosed in the present disclosure, and should be covered within the scope of protection of the present disclosure. Therefore, the scope of protection of the present disclosure should be based on the scope of protection of the claims.

### INDUSTRIAL PRACTICALITY

The embodiments of the present disclosure provide encoding and decoding methods, an encoder, a decoder, and a storage medium. At the encoding side and decoding side, it is determined that a neural network-based in-loop filtering technique is applied to the current block or is allowed to be applied to the current block. A first reconstructed image of the current block is acquired. The first reconstructed image includes a reconstructed sample of the current block. A first edge image of the current block is acquired. The first edge image includes edge information of the reconstructed sample. The first reconstructed image and the first edge image are input into the neural network-based in-loop filtering model to obtain the filtered image of the current block. In this way, the edge image is input as additional side information into the in-loop filtering model, which provides sample-level edge information for the network, the learning of the filtering strength is adjusted at the sample level, the filtering effect is improved, thereby enhancing the quality of the reconstructed image and the decoding performance.

1. A decoding method applied to a decoder, the method comprising:
decoding a bitstream to determine first indication information;
determining, based on the first indication information, that a neural network-based in-loop filtering technique is applied to a current block;
acquiring a first reconstructed image of the current block, wherein the first reconstructed image comprises a reconstructed sample of the current block;
acquiring a first edge image of the current block, wherein the first edge image comprises edge information of the reconstructed sample; and
inputting the first reconstructed image and the first edge image into a neural network-based in-loop filtering model to obtain a filtered image of the current block.

2. The method of claim 1, wherein the edge information comprises edge strength.

3. The method of claim 1, wherein the method further comprises:
acquiring a second reconstructed image of a frame in which the current block is located;
performing edge detection on the second reconstructed image based on a first edge detection operator to determine a second edge image; and
wherein acquiring the first edge image of the current block comprises:
acquiring the first edge image of the current block from the second edge image.

4. The method of claim 3, wherein acquiring the second reconstructed image of the frame in which the current block is located comprises:
acquiring an initial reconstructed image of the frame in which the current block is located; and
taking the initial reconstructed image as the second reconstructed image; or,
performing at least one of deblocking filtering or sample adaptive offset on the initial reconstructed image to obtain the second reconstructed image.

5. The method of claim 3, wherein the method further comprises:
decoding the bitstream to determine an index value of the first edge detection operator; and
determining the first edge detection operator from an edge detection operator list based on the index value of the first edge detection operator.

6. The method of claim 3, wherein the first edge detection operator is a Sobel operator, and
wherein performing the edge detection on the second reconstructed image based on the first edge detection operator to determine the second edge image comprises:
detecting gradient information of the second reconstructed image to determine lateral gradient information and longitudinal gradient information; and
determining the second edge image based on the lateral gradient information and the longitudinal gradient information.

7. The method of claim 6, wherein determining the second edge image based on the lateral gradient information and the longitudinal gradient information comprises:
determining a gradient absolute value of the reconstructed sample based on a lateral gradient in the lateral gradient information and a longitudinal gradient in the longitudinal gradient information of the reconstructed sample; and
taking the gradient absolute value as the edge information of the reconstructed sample.

8. The method of claim 3, wherein after determining the second edge image, the method further comprises:
performing denoising processing on the second edge image to obtain a denoised second edge image.

9. The method of claim 8, wherein performing the denoising processing on the second edge image to obtain the denoised second edge image comprises:
if an edge strength of a first reconstructed sample is greater than or equal to a first threshold, retaining the edge strength of the first reconstructed sample;
if an edge strength of a second reconstructed sample is less than the first threshold, setting the edge strength of the second reconstructed sample to zero.

10. The method of claim 9, wherein the method further comprises:
determining an average value of edge strengths of all reconstructed samples in the second edge image; and
determining the first threshold based on the average value.

11. The method of claim 3, wherein the first edge image and the second edge image are edge images of chroma component, and the method further comprises:
determining a second edge image of luma component and a second edge image of chroma component; and
determining a final second edge image of chroma component based on the second edge image of luma component and the second edge image of chroma component.

12. The method of claim 1, wherein acquiring the first reconstructed image of the current block comprises:
acquiring an initial reconstructed image of a frame in which the current block is located; and
obtaining the first reconstructed image of the current block from the initial reconstructed image.

13. The method of claim 1, wherein the method further comprises:
acquiring at least one of a predicted image of a current block, boundary strength information, slice type information, or quantization information; and
inputting at least one of the predicted image, the boundary strength information, the slice type information, or the quantization information into the neural network-based in-loop filtering model simultaneously to obtain the filtered image of the current block.

14. The method of claim 1, wherein the first indication information comprises a flag of a first syntax element and a flag of a second syntax element,
wherein the flag of the first syntax element indicates whether the neural network-based in-loop filtering technique is allowed to be applied to an image sequence where the current block is located, and the flag of the second syntax element indicates whether the neural network-based in-loop filtering technique is applied to the current block.

15. The method of claim 1, wherein the neural network-based in-loop filtering model comprises an input unit, a feature extraction unit, and an output unit,
wherein inputting the first reconstructed image and the first edge image into the neural network-based in-loop filtering model to obtain the filtered image of the current block comprises:
inputting the first reconstructed image into the input unit, then passing it through the feature extraction unit which inputs output feature information of the first reconstructed image into the output unit; and
inputting the first edge image into the output unit which processes feature maps of the first edge image and the first reconstructed image to output the filtered image.

16. The method of claim 1, wherein the method further comprises:
performing, in a model training phase, edge detection on a training image based on a plurality of edge detection operators to obtain a plurality of edge images;
constructing a training sample set based on the training image, the plurality of edge images and a truth image; and
training the neural network-based in-loop filtering model by using the training sample set to obtain a trained in-loop filtering model.

17. An encoding method applied to an encoder, the method comprising:
determining that a current block is allowed for applying a neural network-based in-loop filtering technique;
acquiring a first reconstructed image of the current block, wherein the first reconstructed image comprises a reconstructed sample of the current block;
acquiring a first edge image of the current block, wherein the first edge image comprises edge information of the reconstructed sample;
inputting the first reconstructed image and the first edge image into a neural network-based in-loop filtering model to obtain a filtered image of the current block;
performing cost calculation based on an original image and the filtered image of the current block to determine a first cost value;
determining whether the neural network-based in-loop filtering technique is applied to the current block based on the first cost value, and setting first indication information of the current block; and
encoding the first indication information, and writing obtained encoded bits into a bitstream.

18. The method of claim 17, wherein the method further comprises:
acquiring a second reconstructed image of a frame in which the current block is located;
performing edge detection on the second reconstructed image based on a first edge detection operator to determine a second edge image; and
wherein acquiring the first edge image of the current block comprises:
obtaining the first edge image of the current block from the second edge image.

19. The method of claim 18, wherein acquiring the second reconstructed image of the frame in which the current block is located comprises:
acquiring an initial reconstructed image of the frame in which the current block is located;
taking the initial reconstructed image as the second reconstructed image; or,
performing deblocking filtering and/or sample adaptive offset on the initial reconstructed image to obtain the second reconstructed image.

20. A non-transitory computer-readable storage medium storing a bitstream generated by an encoding method, wherein the encoder method comprises:
determining that a current block is allowed for applying a neural network-based in-loop filtering technique;
acquiring a first reconstructed image of the current block, wherein the first reconstructed image comprises a reconstructed sample of the current block;
acquiring a first edge image of the current block, wherein the first edge image comprises edge information of the reconstructed sample;
inputting the first reconstructed image and the first edge image into a neural network-based in-loop filtering model to obtain a filtered image of the current block;
performing cost calculation based on an original image and the filtered image of the current block to determine a first cost value;
determining whether the neural network-based in-loop filtering technique is applied to the current block based on the first cost value, and setting first indication information of the current block; and
encoding the first indication information, and writing obtained encoded bits into the bitstream.
